(19) United States
(12) Patent Application Publication
(10) Pub. No.: US 2017/0124903 A1
(43) Pub. Date: May 4, 2017

(54) SYSTEM AND METHOD FOR ENABLING A USER TO OVERCOME ANXIETY

(71) Applicant: DHARMA LIFE SCIENCES LLC, Sleepy Hollow, NY (US)

(72) Inventors: Jonnalagadda Sasidhar, Sleepy Hollow, NY (US); Manisha Naresh Nagpal, Bangalore (IN); Gowthami Vasudev, Bangalore (IN)

(73) Assignee: DHARMA LIFE SCIENCES LLC, Sleepy Hollow, NY (US)

(21) Appl. No.: 14/975,879

(22) Filed: Dec. 21, 2015

Related U.S. Application Data
(63) Continuation-in-part of application No. 14/931,868, filed on Nov. 4, 2015.

(51) Int. Cl. G09B 19/00; A63F 13/50; G09B 5/02

(52) U.S. Cl. CPC G09B 19/00; G09B 5/02; A63F 13/50

(57) ABSTRACT

A method and system are provided for enabling a user to overcome anxiety. The method includes enabling the user to engage in a first activity, a second activity and a third activity. The three activities are performed in virtual environment. The first activity is directed to rewire a first defective wiring of the brain. The first defective wiring results in an individual giving priority to threatening information in the environment. The second activity is directed to rewire a second defective wiring of the brain. The second defective wiring results in an individual failing to make prediction about predictable events. The third activity is directed to rewire a third defective wiring of the brain. The third defective wiring results in an individual believing they do not have control of the situation. The symptom of the first, the second and the third defective wirings is anxiety.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

The subject matter in general relates to behavioral traits in humans, and more particularly but not exclusively, the subject matter is directed to a technical solution to overcome anxiety or worry, which is a weak behavioral trait.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development. As an example, anxiety may be caused by genetic predisposition and unpredictable and/or uncontrollable events that a person may have faced, mainly during childhood.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him. An individual with anxiety may experience, increased heart rate, sweating, headaches and difficulty in breathing. Behavior of such a person may include, failure to think rationally about situations, difficulty in decision making, uneasiness, being upset, discouraged about life and future and increased vigilance, among others.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a focused manner.

In light of the foregoing discussion there is a need for an improved technique to overcome anxiety, which is a weak personality trait.

### SUMMARY

An embodiment provides a system for enabling a user to overcome anxiety. The system includes an activity module. The activity module is configured to enable the user to engage in at least a first activity in a virtual environment, wherein the first activity is directed to rewire a first defective wiring of the brain, wherein the first defective wiring results in an individual focusing or prioritizing non threatening information in environment, be it people, situations, text or pictures; enable the user to engage in at least a second activity in the virtual environment, wherein the second activity is directed to rewire a second defective wiring of the brain, wherein the second defective wiring results in an individual failing to make predictions based on available facts; enable the user to engage in at least a third activity in the virtual environment, wherein the third activity is directed to rewire a third defective wiring of the brain, wherein the third defective wiring causes an individual to believe they do not have control of the situation; provide automated instructions to the user to engage in at least one activity, wherein the one activity is performed in a real world environment, wherein the activity is directed to rewire the first defective wiring of the brain; provide automated instructions to the user to engage in yet another activity, wherein the yet another activity is performed in the real world environment, wherein the yet another activity is directed to rewire the second defective wiring of the brain; provide automated instructions to the user to engage in still another activity, wherein the still another activity is performed in the real world environment, wherein the still another activity is directed to rewire the third defective wiring of the brain.

Another embodiment provides a method for enabling a user to overcome anxiety. The method includes enabling the user to engage in at least a first activity in a virtual environment, wherein the first activity is directed to rewire a first defective wiring of the brain, wherein the first defective wiring results in an individual focusing or prioritizing non threatening information in environment, be it people, situations, text or pictures; enabling the user to engage in at least a second activity in the virtual environment, wherein the second activity is directed to rewire a second defective wiring of the brain, wherein the second defective wiring results in an individual failing to make predictions based on available facts; enabling the user to engage in at least a third activity in the virtual environment, wherein the third activity is directed to rewire a third defective wiring of the brain, wherein the third defective wiring causes an individual to believe they do not have control of the situation, wherein symptom of the first, the second, and the third defective wirings is anxiety.

Yet another embodiment provides a system for enabling a user to overcome anxiety. The system includes an activity module configured to enable the user to engage in at least a first activity in a virtual environment, wherein the first activity is directed to rewire a first defective wiring of the brain, wherein the first defective wiring results in an individual focusing or prioritizing non threatening information in environment, be it people, situations, text or pictures; enable the user to engage in at least a second activity in the virtual environment, wherein the second activity is directed to rewire a second defective wiring of the brain, wherein the second defective wiring results an individual failing to make predictions based on available facts; and enable the user to engage in at least a third activity in the virtual environment, wherein the third activity is directed to rewire a third defective wiring of the brain, wherein the third defective wiring causes an individual to believe they do not have control of the situation, wherein symptom of the first, the second and the third defective wirings is anxiety.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome anxiety;

FIG. 2 is a block diagram of an exemplary activity module 200 to overcome anxiety;

FIG. 2A is a block diagram of an exemplary behavioral traits database 202 of the activity module 200;

FIG. 2B is a block diagram of an exemplary collection of games 204 present in the activity module 200 to overcome anxiety;

FIG. 2C is a block diagram of an exemplary actions database 206 of the activity module 200 to overcome anxiety; and

FIG. 3 illustrates a flowchart of an exemplary method for overcoming anxiety.

### DETAILED DESCRIPTION

I. OVERVIEW
II. PRINCIPLE
III. SYSTEM ARCHITECTURE
IV. MODULES OF SYSTEM TO OVERCOME ANXIETY
V. METHOD FOR OVERCOMING ANXIETY

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome anxiety, which is a weak behavioral trait. The solution is based on a principle that genetic and environmental factors (may be referred to as “cause”) cause defects in human brain wiring (may be referred to as “defect”), and such defects in human brain wiring express themselves in the form of anxiety (may be referred to as “symptoms”); hence, to overcome anxiety, the defective brain wirings have to be rewired, thereby providing a wholesome and long term solution to weak behavioral traits.

In an embodiment, a system is provided to overcome anxiety. The system may include an activity module. The activity module may be configured to enable the user to engage in activities in a virtual environment. The activities in the virtual environment facilitate rewiring of defective brain wirings, wherein the symptom of the defective brain wirings is anxiety. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

The activity in the virtual environment may be a brain game. There may be a plurality of levels in the brain game. Each level in the game may have to be successfully completed by the user to unlock a subsequent higher level in the game.

Respective real world activities may take place in the real world environment, subsequent to at least participating respective brain games. There may be a plurality of levels in the real world activity.

### II. Principle

Anxiety may be an internal state of heightened apprehension that occurs even in the immediate absence of any threat. In other words, anxiety may be an internal state of heightened apprehension that occurs in the expectation of future threat. Anxiety may often be accompanied by muscular tension, restlessness, fatigue and problems in concentration. People facing anxiety may withdraw from situations which have provoked anxiety in the past. Anxiety can be either a short-term state or a long-term trait.

Anxiety is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to anxiety, the brain of a person with anxiety is wired such that the person gives priority to threatening information in the environment, be it people, situations, text or pictures, which may be considered as a defective brain wiring. Further, the brain of the person with anxiety is wired such that the person fails to make predictions about predictable events, which may be considered as yet another defective brain wiring. Furthermore, the brain of the person with anxiety is wired such that the person believes that he/she does not have control of the situation, which may be considered still another defective brain wiring. Such defective brain wirings may have been caused by genetic predisposition and negative experiences in early life.

A wholesome approach to overcome or alleviate anxiety in a person would be to implement ways to rectify defects in the brain wiring. Embodiments provide a solution to rewire the defective brain wirings (addressing the defect) rather than just addressing the behavioral trait (symptom) without addressing the core defect. The solution is directed towards rewiring the defective brain wirings such that the ability to focus on non threatening information in environment is increased, the ability to make predictions based on available facts is increased and the person gains control of the situation by choosing the best solution available.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

Individuals with anxiety give priority to threatening information in the environment, be it people, situations, text or pictures, fail to make prediction about predictable events and believe that they do not have control of the situation, which may be considered as defective brain wirings. Different brain regions and neural network of the individual are responsible for such defects. The brain regions involved in anxiety include the amygdala and other cortical structures and the connections between them. In anxious individuals, high neural activity is seen in the amygdala region by input related to previous conditioning and reinforcement experiences. The previous experiences are conveyed by projections from the thalamus and the prefrontal cortical (PFC) structures.

PFC structures participate in interpreting the higher-order significance of experiential stimuli, in modifying behavioral responses based on competing reward versus punishment contingencies, and in predicting the outcomes of our responses to emotional events. These areas share extensive, reciprocal projections with the amygdala, through which the amygdala can modulate PFC neuronal activity and the PFC can modulate amygdala-mediated responses to emotionally salient stimuli. In patients with anxiety, the connection from the amygdala to the prefrontal cortex (PFC) is strong; however, the connection from the PFC to the amygdala is weak.

In situations which are predictable, the thalamus sends the signals to the PFC and the amygdala. The new pattern is mapped by the hippocampus to any previous pattern which is present in the memory. The PFC analyzes what response the stimulus requires and what emotion should be attributed. Collectively these three interact to activate the response/next pattern which involves the motor region.

In situations which are unpredictable, the stimulus does not match any specific previous pattern present in the memory. This results in over activation of orbito frontal cortex and anterior cingulate cortex, which in turn activates the amgydala to produce a threatening response to the stimuli. Over a period of time, this over activation of the cortical structures actually damages it further, impairing other functions of these regions such as reward anticipation, decision making, and empathy and impulse control. As a result, the individual may not be able to predict the future outcomes and continues feeling anxious.

In controllable situations, the thalamus sends the signals to the PFC and the amygdala. The Hippocampas maps this pattern to any previous pattern which is present. The PFC analyzes what response the stimulus requires and what emotion should be attributed. Collectively these three interact to activate the response/next pattern which involves the motor region.

In an uncontrollable situation, the thalamus sends the signals to the PFC. The PFC then sends a signal to the Amygdala and DRN to respond with anxiety and fear as the stimulus is perceived as threatening. The DRN then secretes serotonin and the hypothalamus secretes cortisol, in order to make the person feel better and cope up with the situation. Since the situation is uncontrollable, the outcome is negative and this entire memory is stored in the hippocampus. If these situations keep repeating again and again, then these hormones and neurotransmitters further damage the PFC, its dendrites and the connections. The next time when the same situation occurs, the signal is directly sent to the amygdala to respond with anxiety and this loop is strengthened.

### III. System Architecture

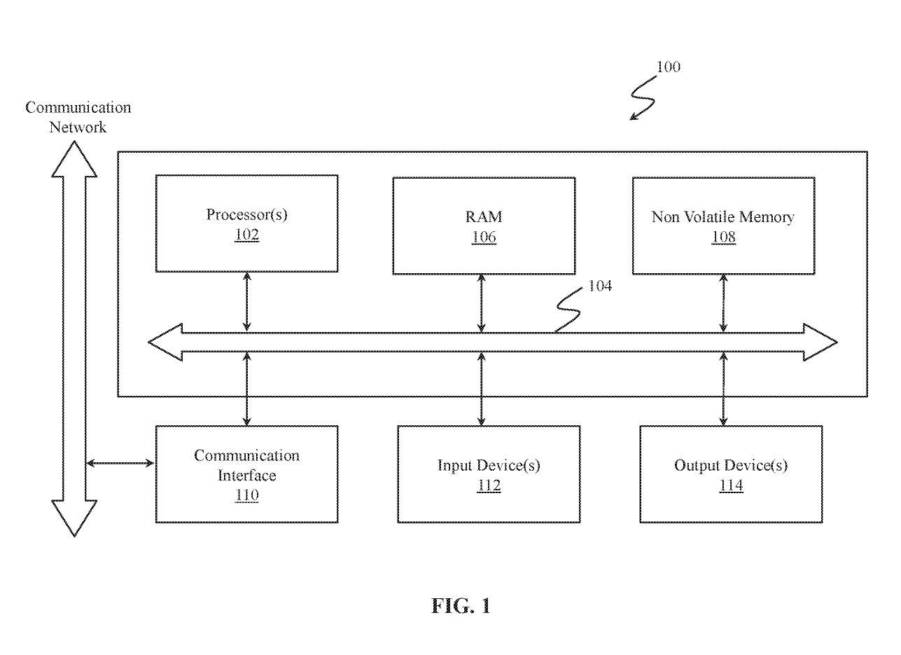

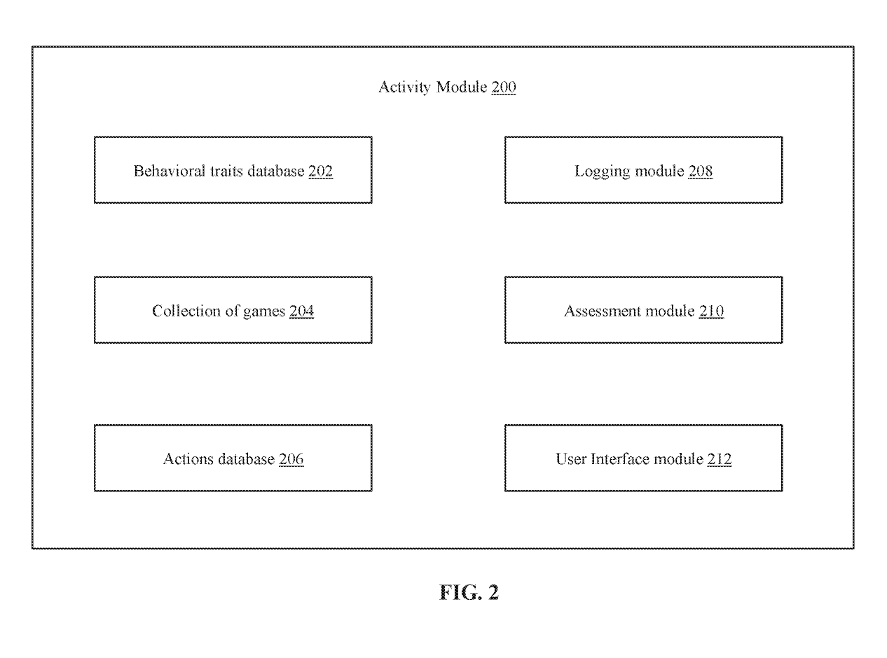

Referring to the figures, more particularly to FIG. 1, an exemplary architecture of an exemplary system 100 to overcome anxiety is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more computer processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome Anxiety

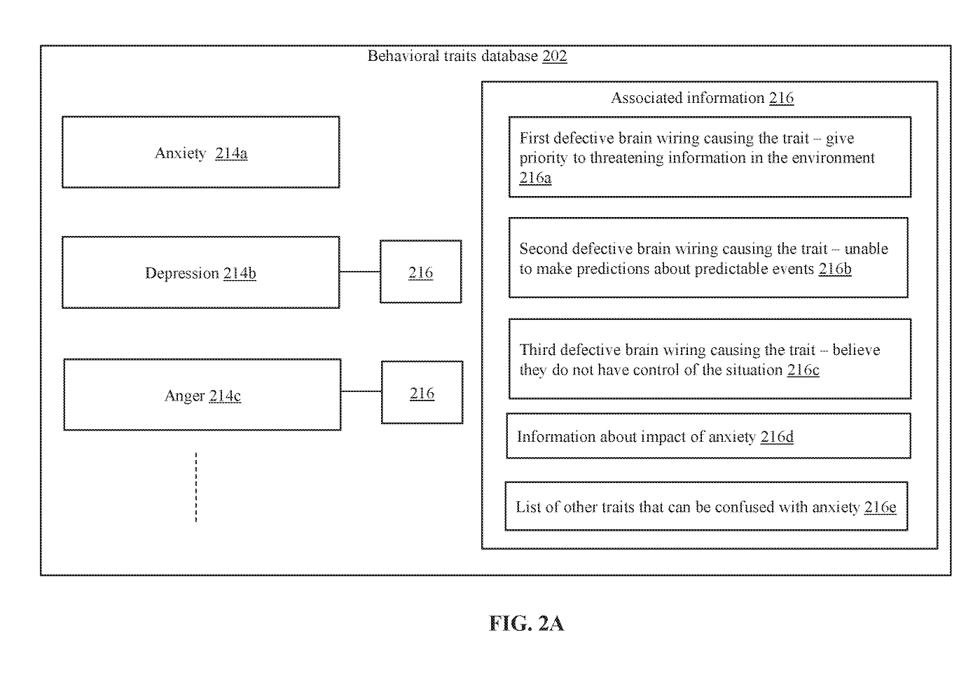

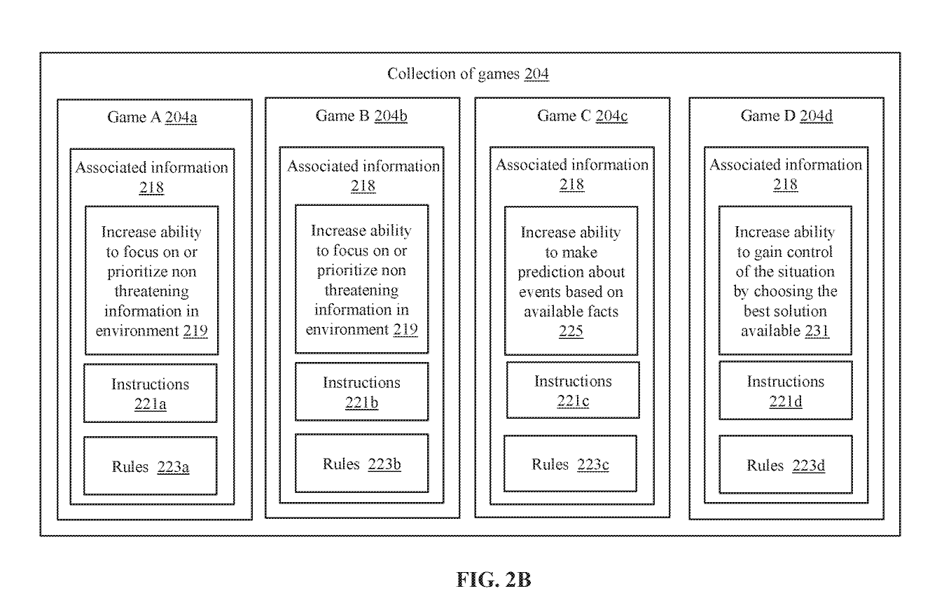

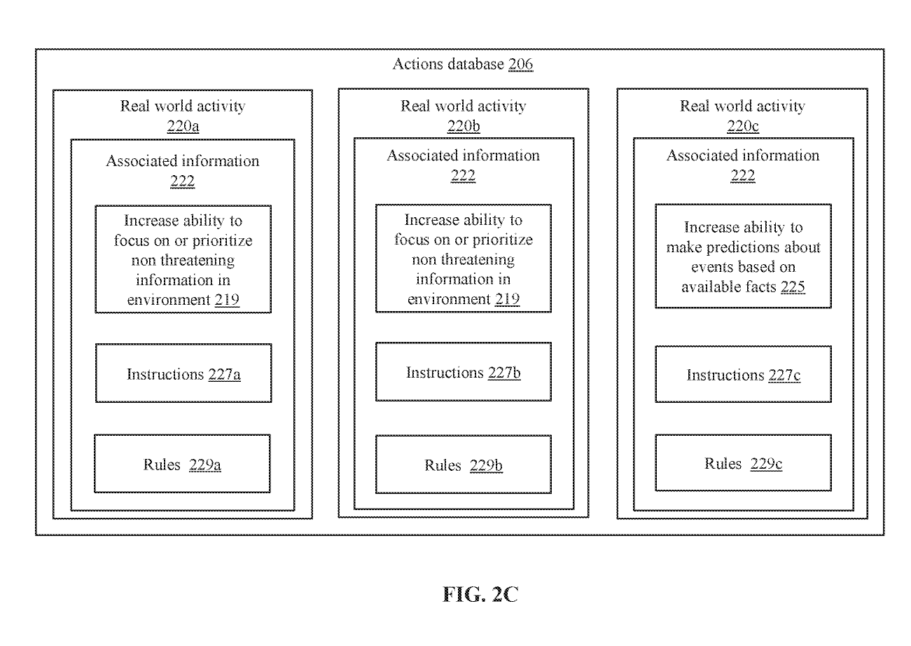

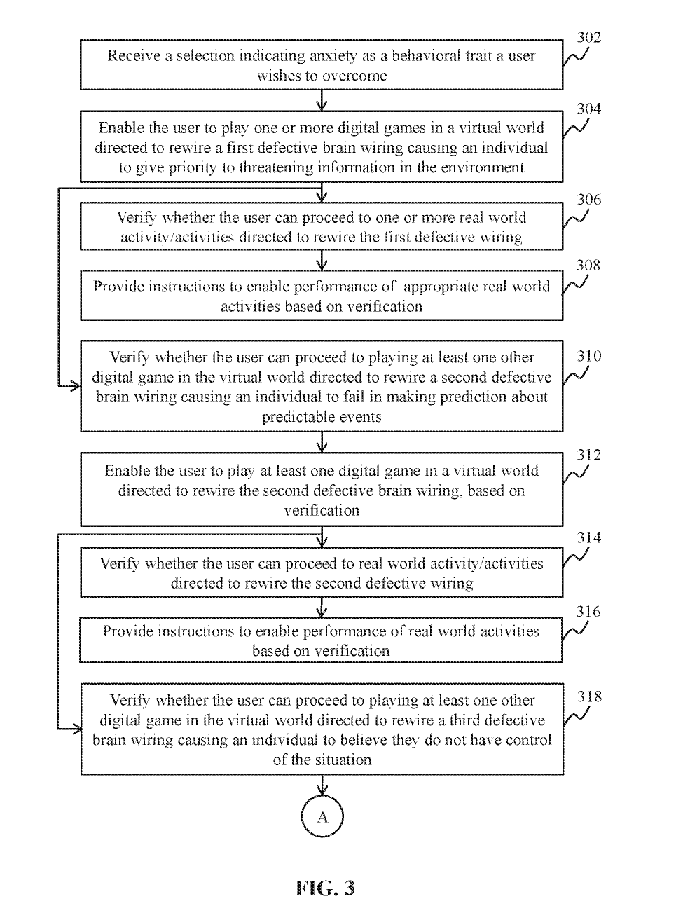

Referring to the figures, and more particularly to FIG. 2, the system 100 includes various modules for enabling users to overcome anxiety. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. Examples of behavioral traits 214 include, but not limited to, anxiety 214a, depression 214b and anger 214c, among others. The traits database 202 may further include, with respect to one or more of the behavioral traits, information associated 216 with the trait 214.

With regards to anxiety 214a, the associated information 216 may include information corresponding to the defective brain wirings (defects) 216a, 216b and 216c causing anxiety (symptom of the defect), information about impact 216d of anxiety 214a on a person, and a list 216e comprising one or more traits that may be confused with anxiety 214a, among other information. Some or all of the associated information 216 may be displayed to the user of the activity module 200.

A first defective brain wiring 216a causing anxiety 214a is the brain wiring causing an individual to give priority to threatening information in the environment. A second defective brain wiring 216b causing anxiety 214a is the brain wiring causing an individual to fail in making correct prediction about predictable events. A third defective brain wiring 216c causing anxiety 214a is the brain wiring causing an individual to believe they do not have control of the situation.

In an embodiment, the information corresponding to the first, second, and the third defective brain wirings 216a, 216b and 216c causing anxiety 214a enables the activity module 200 to select games, activities or actions to overcome anxiety 214a.

In an embodiment, displaying the information corresponding to the defective brain wirings (defects) 216a, 216b and 216c causing anxiety 214a helps the user in understanding the defects responsible for anxiety 214a, thereby motivating the user to follow the instructions provided by the activity module 200.

Information about impact 216d of anxiety 214a can include one or more of symptoms including increased heart rate, sweating, headaches, difficulty in breathing, failure to think rationally about situations, difficulty in decision making, uneasiness, being upset, discouraged about their life and future, and being more vigilant than normal people, among others.

The list 216e of other traits that may be confused with anxiety 214a include social anxiety, worry and stress, among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome anxiety 214a.

With regards to anxiety 214a, the brain rewiring attempted to achieve to overcome anxiety 214a includes rewiring the defective brain wirings 216a, 216b and 216c such that ability to focus on or prioritize non threatening information in environment is increased, ability to make predictions based on available facts is increased and ability to gain control of the situation by choosing the best solution available is increased.

In an embodiment, the activity module 200 may display the information corresponding to the causes (genetic or environmental) that resulted in the defective brain wirings (defects) 216a, 216b and 216c which in turn resulted in anxiety 214a, thereby enabling the user to relate to the cause, defect and symptom of the defect, which results in a wholesome experience while working to overcome anxiety 214a.

### Collection of Games 204

The activity module 200 includes a collection of digital games 204, which are played in a virtual world. Each of the games 204 is used by the activity module 200 based on the brain rewiring, which the game 204 is capable of achieving.

Referring to FIG. 2B, in an embodiment, each game 204a-204d (may be referred to as game 204 or games 204) may include associated information 218. As an example, a game may be capable of achieving more than one type of brain rewiring. Alternatively, one type of rewiring may be achieved through more than one type of games. Each game 204 includes data indicating the brain rewiring(s) 219, 225 and 231 it is capable of achieving, so that the activity module 200 can opt to present a choice of one or more games, which has the capability to achieve the brain rewiring, which the activity module 200 is attempting to achieve.

The associated information 218 may further include instructions 221 to be followed by the user to play the game 204. The associated information 218 may additionally include one or more rules 223. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

In the example presented in FIG. 2B, Game A 204a and Game B 204b may be directed at rewiring 219 the brain to increase ability to focus on or prioritize non threatening information in environment. Game B 204b may be directed at increasing the ability to positively interpret situations. Game C 204c may be directed at rewiring 225 the brain to increase ability to make predictions based on available facts and Game D 204d may be directed at rewiring 231 the brain to increase ability to gain control of the situation by choosing the best solution (as may be perceived) available. The games 204a, 204b, 204c and 204d can be used by the activity module 200 to correct the defective brain wirings 216a, 216b and 216c by rewiring the brain. All the games 204 are played/participated in a virtual environment, such as a game in a virtual world.

Game A 204a may be designed to increase the ability to focus on or prioritize non threatening information in environment. The instruction 221 a may include recommendation to play the game 204a for at least a predefined duration for a predefined number of days. The rules 223a may allow proceeding to a next level in the game 204a once a desired level of performance is achieved.

Game A 204a may present an example of a possible real life situation/event. Game A 204a may include selective bias training to focus on cues such as pictures (both threatening and non threatening) and words (both threatening and non threatening) where individuals are trained to focus on the non threatening stimuli.

In a first level, stimuli including one happy and one threatening face people (ex: real people) may be shown to the user. The goal is to see how fast the user can select the positive stimuli over the threatening stimuli. A track of the time may be kept, which may not be shown to the user. Once they are able to select the positive stimuli in less than 100 ms for at least ten pairs in each level, only then they may be allowed to move to the next level.

The first level may include one or more sub levels. In sub level 1, two stimuli (faces of people), one happy and one threatening face of real people may be shown on the activity module 200 to the user. This pair (but with different faces) may repeat again and again till the end of a time limit. In a sub level 2, the number of stimuli may be increased, for example, two threatening and one positive face may be shown. In sub level 3, stimuli shown may be happy and neutral faces or neutral and threatening faces, the use may have to pick happy face in the first case and neutral face in the second case. In sub level 4, stimuli may include four faces out of which one may be the happy face and the others could be threatening or neutral faces.

A second level of Game A 204a, stimuli in the form of words may be shown to the user. The rules 223a and instructions 221a for playing the second level of this game may be similar to the first level. The goal may be to see how fast the user can select positive stimuli over threatening stimuli. Once the user is able to select the positive stimuli, only then they may be allowed to move to the next level.

The second level may include one or more sub levels. In sub level 1, two words, one positive or non-threatening and one threatening may be shown to the user. The pair of words (but different set of words) may repeat again and again till the end of a time limit. The user may have to select the positive or non threatening word each time the words (or pair of words) are shown to him to proceed to the next level. In sub level 2, the number of stimuli may be increased, for example, two negative and one positive word may be shown. In sub level 3, either happy and neutral words may be shown or neutral and threatening words may be shown. In sub level 4, stimuli may include four words out of which one will be the happy and the others could be threatening or neutral.

A third level of Game A 204a, stimuli in the form of pictures of situations may be shown. The third level may include one or more sub levels. In sub level 1, stimuli may have two pictures of situations (one positive and one threatening). Such pair (but different set of pictures) may repeat again and again till a predefined number of pairs are shown. Stimuli (happy and threatening faces of a real person) can be shown for 500 milliseconds. In sub level 2, stimuli may include four situations out of which one will be happy, the others could be threatening or neutral. In sub level 3, one positive picture with a threatening word and another positive picture with a nonthreatening word, and vice versa, may be shown to the individual. The individual may have to choose the option where both stimuli (the word and picture) are positive.

Game B 204b may be designed for rewiring 219 the first defective brain wiring 216a. Game B 204b may be directed at increasing the ability to positively interpret situations. In an embodiment, Game B 204b may be configured to be played when a user has played/participated in at least a level or all levels of Game A 204a. The instructions 221b may include recommendation to play the game 204b for at least a predefined duration for a predefined number of days. The rules 223b may allow proceeding to a next level in the game 204b once a desired level of performance is achieved.

Game B 204b may present an example of a possible real life situation/event.

Individuals with anxiety have a higher tendency to have a negative interpretation of a situation. Worry can be classified as follows—(a) worries about current problems, such as work, exams, financial issues and relationships, among others, (b) worries about hypothetical situations, such as plane crash, probable environmental disasters and diseases when one gets older, among others. Game B 204b may be directed at focusing on paragraphs and sentences, where the individual has to choose the positive interpretation of each scenario mentioned.

In a first level, a sentence with one or more missing words in the sentence could be shown to the individual. The individual is required to fill the blanks with a positive word that may complete the sentence. An example is presented below:
Example: “As you get ready to go to a party, you think the new people you meet there will find you ______.”
The individual may have to complete ten such sentences before proceeding to the next level.

In a second level, individuals have to choose a positive word among three words to complete a sentence. The words could be positive, negative and neutral. According to instructions 221b, ten sentences will be shown for each game play. An example is presented below:
Example: “My new job will be ____ appealing/boring/normal.”
The participants may not be awarded points for negative or neutral words.

In a third level, individuals have to choose the most suitable positive word for a sentence in a crossword which includes two positives and two negatives. Points may vary based on what they choose.

In a fourth level, ambiguous sentences may be presented and they have to choose the most positive interpretation. An example is presented below:
Example: “As you give a speech at your friend's wedding, you notice some people in the audience starting to laugh.”
Your interpretations could be:
As you speak, people in the audience laugh appreciatively.
As you speak, people in the audience find your efforts laughable.

Game C 204c may be designed to increase the ability to make correct predictions based on available facts. The instruction 221c may include recommendation to play the game 204c for at least a predefined duration for a predefined number of days. The rules 223c may allow proceeding to a next level in the game 204c once a desired level of performance is achieved.

Game C 204C may present an example of a possible real life situation/event. A list of facts may be presented in the form of a short story and the user has to consider all the facts to make a prediction of what the future outcome would be. As an example, 70% of the time, the prediction needs to be positive and only 30% of the cases, the prediction needs to be negative. Four options may be provided and the user has to choose the most appropriate prediction. Points will be given for the correct response. Examples are presented below:

### EXAMPLE 1

Peter has an important presentation to make tomorrow

### True Facts:

He has collected sufficient information on the topic
The committee is critical
He has rehearsed the presentation several times
He is a good speaker

Question: According to you, will John perform well in the exam:

### Answer Choices:

Yes
No

The positive interpretation that the user is required to choose is “Yes”

### EXAMPLE 2

Robert has a phone interview in the evening.

### True Facts:

His battery is low
His colleague has a charger
He has prepared well
He has strong communication skills

According to you, will Robert's interview go well?
Yes
No

The positive interpretation that the user is required to choose is “Yes”

Game D 204d may be designed to increase the ability to gain control of the situation by choosing the best solution (as may be perceived) available. The instruction 221d may include recommendation to play the game 204d for at least a predefined duration for a predefined number of days. The rules 223d may allow proceeding to a next level in the game 204d once a desired level of performance is achieved.

Game D 204d may present an example of a possible real life situation/event. The individual is presented with a scenario where he/she needs to decide what course of action needs to be taken next in order to get out of the problem or solve the problem and ensure a positive outcome. A list of options may be provided and the user has to choose the most appropriate solution. An examples is presented below:

### Example

A flight has to do an emergency landing and the pilot sends an SOS signal before landing. It will take two/three days before the rescuers arrive so what would you choose to do to ensure maximum chances of survival:
Take packets of food and water
Take a flag from the plane and hoist it so the rescuers can find you
Take a gun/knife to protect yourself from any dangerous situations
Take lots of heavy clothes/blankets to protect you from any change of climate

Correct answer: Take packets of food and water

### Actions Database 206

The actions database 206 includes information corresponding to a plurality of real world activities or sets of real world activities. Real world activities may include activities that are performed in a real world environment, as opposed to the digital games played in the virtual world (ex: games included in the collection of games 204).

Referring to FIG. 2C, each real world activity 220a-220c or sets of real world activities 220a-220c (may be referred by numeral 220) are used by the activity module 200 based on the brain rewiring, which the real world activity 220 is capable of achieving.

Each real world activity 220 may include associated information 222. As an example, a real world activity may be capable of achieving more than one type of brain rewiring. Each real world activity 220 includes data indicating the brain rewiring(s) 219 and 225, it is capable of achieving, so that the activity module 200 can opt to present a choice of one or more real world activities 220, which has the capability to achieve the brain rewiring, which the activity module 200 is attempting to achieve.

The associated information 222 may further include instructions 227 to be followed by the user to perform the real world activity 220 or a set of real world activities 220. The associated information 222 may additionally include one or more rules 229. Examples of rules include rules to proceed to a higher level, scoring method in each level and time assigned to each level to reach the end of the level, among others.

The real world activity 220a may be presented to the user after the user has at least participated in one or more games to a predefined extent that attempts to rewire 219 the first defective brain wiring 216a. The real world activity 220a may be designed to rewire the brain to increase the ability to focus on or prioritize non threatening information in the environment 219.

The activity module 200 may recommend tasks to be performed by the users in one or more levels.

### Level 1:

In your environment, focus on the people who are happy and count those number of happy people you see every day and make a note of it at night. Write down the names of those people, as many as you can. Carry out this activity for one week.

### Level 2:

In a newspaper or book that you are reading, focus on at least 20 positive words and circle them. Write down as many of those words as possible. Carry out this activity everyday for 1 week.

### Level 3:

Focus on at least two positive situations that you encounter in your daily life and make a note of those situations at night. Carry out this activity every day, for one week.

The real world activity 220b may be presented to the user after the user has participated in Game B 204b at least to a predefined extent. The real world activity 220b may be designed to increase the ability to focus on or prioritize non threatening information in the environment 219. The ability to positively interpret situations may be achieved through the real world activity 220b. The instructions/tasks within the real world activity 220b can include the following:

Think and write down at least one new situation which you are about to encounter during your day today and interpret that positively. Carry out this activity for one week.

The real world activity 220c may be presented to the user after the user has participated in Game C 204c at least to a predefined extent. The real world activity 220c may be designed to make the correct predictions based on available facts 225. The instructions/tasks within the real world activity 220c can include the following:

In the morning, write down a situation that you encounter everyday and predict how it would turn out for that particular day. Further, write down a new situation that you are about to encounter today and predict how it would turn out to be, depending on the facts that you have at hand. Once both the situations are over, make a note whether your prediction was right or wrong.

In an embodiment, the activity module 200 also provides instructions to carry out real world activity for increasing ability to gain control of the situation by choosing the best solution available.

In an embodiment, the action database 206 further includes plurality of physical actions, mind actions and dietary actions, one or more of which may be presented to a user who is trying to overcome anxiety 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, real world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real world activities and determines scores of each level of real world activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. Method for Overcoming Anxiety

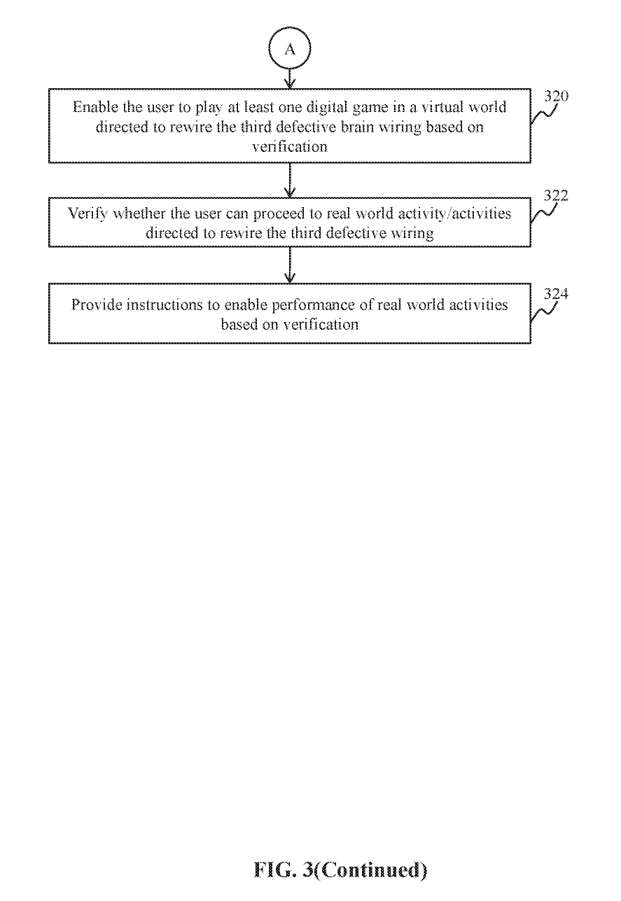

Now referring more particularly to FIG. 3, a method is provided for overcoming anxiety 214a. A selection indicating anxiety 214a as a behavioral trait which a user wishes to overcome is received at step 302. At step 304, a user is enabled to participate in/play one or more digital games 204a and 204b, which are played in a virtual world. The digital games 204a and 204b are instrumental in rewiring 219a first defective brain wiring 216a, causing an individual to give priority to threatening information in the environment, whose symptom is exhibition of anxiety 214a. At step 306, verification is made to determine whether the user can proceed to perform one or more real world activities 220a and 220b corresponding to digital games 204a and 204b respectively. In case it is determined that the user can proceed, then at step 308, instructions are provided to the user to enable the user to perform appropriate real world activity/activities 220a and/or 220b. Preferably, the user is allowed to perform or instructed to begin performing appropriate real world activities 220a and/or 220b upon participating in the digital game 204a and/or 204b at least to a predefined extent, which is determined based on the desired rewiring. The real world activity 220a and 220b are instrumental in rewiring 219 the first defective brain wiring 216a, whose symptom is exhibition of anxiety 214a. At step 310, verification is made to determine whether the user can proceed to playing at least one other digital game 204c in the virtual world directed to rewire a second defective brain wiring 216b causing an individual to fail in making prediction about predictable events. In case it is determined that user can proceed, then at step 312 the user is enabled to participate/play in at least one digital game 204c, which is played in a virtual world. The digital game 204c is instrumental in rewiring 225 the second defective brain wiring 216c, whose symptom is exhibition of anxiety 214a. Preferably, the user is allowed to proceed to playing at least one other digital game 204c upon participating in the games instrumental in rewiring 219, which is determined, based on the desired rewiring. At step 314, verification is made to determine whether the user can proceed to perform real world activities 220c. In case it is determined that user can proceed, then at step 316, instructions are provided to the user to enable the user to perform appropriate real world activity/activities 220c. Preferably, the user is allowed to perform or instructed to begin performing appropriate real world activities 220c upon participating in the digital games 204c at least to a predefined extent, which is determined based on the desired rewiring. The real world activity 220c is instrumental in rewiring 225 the second defective brain wiring 216b, whose symptom is exhibition of anxiety 214a.

At step 318, verification is made to determine whether the user can proceed to playing at least one other digital game 204d in the virtual world directed to rewire a third defective brain wiring 216d causing an individual to believe they do not have control of the situation. In case it is determined that user can proceed, then at step 320 the user is enabled to participate/play in at least one digital game 204d, which is played in a virtual world. The digital game 204d is instrumental in rewiring 231 the third defective brain wiring 216c, whose symptom is exhibition of anxiety 214a. Preferably, the user is allowed to proceed to playing at least one other digital game 204d upon participating in the game(s) instrumental in rewiring 225 the second defective wiring 216b at least to a predefined extent, which is determined based on the desired rewiring. At step 322, verification is made to determine whether the user can proceed to perform real world activities. In case it is determined that user can proceed, then at step 324, instructions are provided to the user to enable the user to perform appropriate real world activity/activities. Preferably, the user is allowed to perform or instructed to begin performing appropriate real world activities upon participating in the digital games 204d at least to a predefined extent, which is determined based on the desired rewiring. The real world activity is instrumental in rewiring 231 the third defective brain wiring 216c, whose symptom is exhibition of anxiety 214a.

Referring to the step (302) of receiving a selection indicating anxiety 214a, the user may be provided an option to select a behavioral trait that he would like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of anxiety 214a, the activity module 200 may display a list 216e of other behavioral traits that can be confused with anxiety 214a, so that the user can select a more appropriate behavioral trait 214, which he desires to work on. The activity module 200 may further display the information corresponding to the brain wirings (defect) 216a, 216b and 216c causing the behavioral trait 214. The first defective brain wiring 216a causes an individual to mostly give priority to threatening information in the environment, be it people, situations, text or pictures. The second defective brain wiring 216b causes an individual to fail in making prediction about predictable events. The third defective brain wiring 216c causes an individual to believe they do not have control of/over the situation.

The activity module 200 may additionally display information about impact 216d of anxiety 214a on the user. In addition, the activity module 200 may display information corresponding to the brain rewiring 219, 225 and 231 that the activity module 200 is attempting to achieve to overcome anxiety 214a. Rewiring 219 of the first defective brain wiring 216a results in increased ability to focus on and prioritize non threatening information in environment, be it people, situations, text or pictures. Rewiring 225 of the second defective brain wiring 216b results in increased ability to make the predictions based on available facts. Rewiring 231 of the third defective brain wiring 216c results in increased ability to gain control of the situation by choosing the best solution available.

Furthermore, the activity module 200 may display the information corresponding to the causes (genetic or environmental) that resulted in the defective brain wirings (defect) 216a, 216b and 216c.

Referring to the step (304) of enabling the user to play at least one digital game in the virtual world directed to rewire the first defective brain wiring 216a, the activity module 200 may select one or more digital games based on the capability of the digital games (ex: Game A 204a, Game B 204b) to achieve the desired brain rewiring 219.

The activity module 200 may provide a choice (one or more games) of games, from which the user may select. The activity module 200 may even indicate the effectiveness of each of the games in achieving the desired brain rewiring 219 or an aspect of rewiring.

In an embodiment, the activity module 200 is configured to recommend a plurality of games 204, wherein the recommendation indicates each of the games' 204 effectiveness to achieve the desired brain rewiring 219 or an aspect of rewiring.

The activity module 200 allows the user to play the selected game. The logging module 208 may log the performance of the user. The assessment module 210 may determine the performance scores using the log in the logging module 208. Further, based on the respective rules 223, the user is either allowed or denied access to other levels of the game 204.

Referring to step 306, the activity module 200 verifies whether the user can proceed to perform real world activities 220. Preferably, the activity module 200 recommends real world activities 220 after the user has performed to a desired extent in the digital game(s) 204. Desired extent of performance can be, as an example, levels completed, score reached and/or duration over which the game 204 was played.

In an embodiment, the activity module 200 recommends (step 308) participating in real world activity 220a after the user has performed to a desired extent in the digital game 204a. Likewise, the activity module 200 recommends participating in real world activity 220b after the user has performed to a desired extent in the digital game 204b. Desired extent of performance can be, as an example, levels completed, score reached and duration over which the game 204a was played.

In an embodiment, the activity module 200 recommends participating in a level of real world activity after the user has performed to a desired extent in a level of the digital game, wherein the level of the digital game prepares the user to participate in the level of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

The logging module 208 may log the performance of the user. The assessment module 210 may determine the performance scores using the log in the logging module 208. Further, based on the rules 229, the user is either allowed or denied access to other levels of the real world activities or sets of real world activities.

Referring to step 310, the activity module 200 verifies whether the user can proceed to playing at least one other digital game 204c in the virtual world directed to rewire the second defective brain wiring 216b. Rewiring 225 the brain wiring causing an individual to fail in making prediction about predictable events.

In an embodiment, the activity module 200 recommends participating in digital games directed to rewire the second defective brain wiring 216b causing an individual to fail in making prediction about predictable events after the user has performed to a desired extent in the digital game(s) directed to rewire the first defective brain wiring 216a.

In an embodiment, the activity module 200 recommends participating in digital games directed to rewire the second defective brain wiring 216b after the user has performed to a desired extent in the digital game(s) and real world activity/activities directed to rewire the first defective brain wiring 216a.

The activity module 200, based on the verification, enables the user to play/participate in at least one other digital game 204c in the virtual world directed to rewire the second defective brain wiring 216b.

In an embodiment, the activity module 200 recommends (steps 314, 316) participating in real world activity 220c after the user has performed to a desired extent in the digital game 204c. Likewise steps 318 to 324 are performed for the third defective wiring 216c, as is done for first and the second defective wiring 216a and 216b.

Additionally, the activity module 200 may provide instructions to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real world, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting anxiety, the activity module 200 provides a scale operable by the user to select a position on the scale. The position may be indicative of the user's perception of anxiety. Alleviation of anxiety resulting from the rewiring of the brain achieved by the performance of the activities (virtual games or real world activities) enabled by the activity module 200 is reflected on the scale. Degradation of the alleviation of anxiety resulting from the degradation of the rewiring of the brain due to premature halt in performance of the activities (virtual games or real world activities) enabled by the activity module 200 is also reflected on the scale.

The games and the real world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome anxiety, the system comprising an activity module configured to:
enable the user to engage in at least a first activity in a virtual environment, wherein the first activity is directed to rewire a first defective wiring of the brain, wherein the first defective wiring results in an individual giving priority to threatening information in the environment;
enable the user to engage in at least a second activity in a virtual environment, wherein the second activity is directed to rewire a second defective wiring of the brain, wherein the second defective wiring results in an individual failing to make predictions about predictable events;
enable the user to engage in at least a third activity in a virtual environment, wherein the third activity is directed to rewire a third defective wiring of the brain, wherein the third defective wiring results in an individual believing they do not have control of situation, wherein symptom of the first, the second and the third defective wirings is anxiety;
provide automated instructions to the user to engage in at least one activity, wherein the one activity is performed in a real world environment, wherein the activity is directed to rewire the first defective wiring of the brain;
provide automated instructions to the user to engage in yet another activity, wherein the yet another activity is performed in the real world environment, wherein the yet another activity is directed to rewire the second defective wiring of the brain; and
provide automated instructions to the user to engage in still another activity, wherein the still another activity is performed in the real world environment, wherein the still another activity is directed to rewire the third defective wiring of the brain.

2. The system of claim 1, wherein the activities in the virtual environment are digital games.

3. The system of claim 1, wherein the activity module is further configured to:
provide the automated instructions to engage in the activity directed to rewire the first defective wiring, to be performed in the real world environment, after the user has at least participated in the first activity;
provide the automated instructions to engage in the activity directed to rewire the second defective wiring, to be performed in the real world environment, after the user has at least participated in the second activity; and
provide the automated instructions to engage in the activity directed to rewire the third defective wiring, to be performed in the real world environment, after the user has at least participated in the third activity.

4. The system of claim 1, wherein the activity module is further configured to enable the user to engage in the second activity, after the user has at least participated in the first activity.

5. The system of claim 1, wherein the activity module is further configured to enable the user to engage in the third activity, after the user has at least participated in the first and the second activity.

6. A method for enabling a user to overcome anxiety, the method comprising: enabling the user to engage in at least a first activity in a virtual environment, wherein the first activity is directed to rewire a first defective wiring of the brain, wherein the first defective wiring results in an individual giving priority to threatening information in the environment;
enabling the user to engage in at least a second activity in the virtual environment, wherein the second activity is directed to rewire a second defective wiring of the brain, wherein the second defective wiring results in an individual failing to make predictions about predictable events; and
enabling the user to engage in at least a third activity in the virtual environment, wherein the third activity is directed to rewire a third defective wiring of the brain, wherein the third defective wiring results in an individual believing they do not have control of the situation, wherein symptom of the first, the second and the third defective wirings is anxiety.

7. The method of claim 6, further comprising providing automated instructions to the user to engage in at least one activity, wherein the one activity is performed in a real world environment, wherein the activity is directed to rewire the first defective wiring of the brain.

8. The method of claim 7, wherein the automated instructions to engage in the activity directed to rewire the first defective wiring, to be performed in the real world environment, is provided after the user has at least participated in the first activity.

9. The method of claim 6, further comprising providing automated instructions to the user to engage in at least one activity, wherein the one activity is performed in a real world environment, wherein the activity is directed to rewire the second defective wiring of the brain.

10. The method of claim 9, wherein the automated instructions to engage in the activity directed to rewire the second defective wiring, to be performed in the real world environment, is provided after the user has at least participated in the second activity.

11. The method of claim 6, further comprising providing automated instructions to the user to engage in at least one activity, wherein the one activity is performed in a real world environment, wherein the activity is directed to rewire the third defective wiring of the brain.

12. The method of claim 11, wherein the automated instructions to engage in the activity directed to rewire the third defective wiring, to be performed in the real world environment, is provided after the user has at least participated in the third activity.

13. The method of claim 6, wherein the user is enabled to engage in the second activity, after the user has at least participated in the first activity.

14. The method of claim 6, wherein the user is enabled to engage in the third activity, after the user has at least participated in the first activity and the second activity.

15. A system for enabling a user to overcome anxiety, the system comprising an activity module configured to:
enable the user to engage in at least a first activity in a virtual environment, wherein the first activity is directed to rewire a first defective wiring of the brain, wherein the first defective wiring results in an individual giving priority to threatening information in the environment;
enable the user to engage in at least a second activity in the virtual environment, wherein the second activity is directed to rewire a second defective wiring of the brain, wherein the second defective wiring results in an individual failing to make prediction about predictable events; and
enable the user to engage in at least a third activity in a virtual environment, wherein the third activity is directed to rewire a third defective wiring of the brain, wherein the third defective wiring results in an individual believing they do not have control of the situation, wherein symptom of the first, the second and the third defective wirings is anxiety.

16. The system of claim 15, wherein,
the first activity is directed to rewire the first defective wiring to increase ability to focus on and/or prioritize non threatening information in environment;
the second activity is directed to rewire the second defective wiring to increase ability to make predictions based on available facts; and
the third activity is directed to rewire the third defective wiring to increase ability to gain control of the situation by choosing the best solution available.
